(19) United States
(12) Patent Application Publication
(10) Pub. No.: US 2011/0148357 A1
(43) Pub. Date: Jun. 23, 2011

(54) Battery charger base capable of connecting external AC power

(76) Inventor: Sheng-Fu Lu, Taoyuan (TW)

(21) Appl. No.: 12/003,955

(22) Filed: Jan. 3, 2008

(51) Int. Cl. H02J 7/02

(52) U.S. Cl. 320/111

(57) ABSTRACT

The present invention discloses a battery charger base which is a structure having several battery charges stacked with each other and connected to an external AC power. The battery charger base does not occupy an insert hole of a socket, while providing an application of connecting several battery chargers to an external AC power. In the battery charger base, a main body of the charger includes an input plug, a charge rectification circuit, a charge slot, an overload protection circuit and an external AC power socket. The charge circuit is electrically connected to the input plug for inputting an AC power and preventing the circuit from having a load of a large current. The external AC power socket is electrically connected to the overload protection circuit for outputting a stable AC power.

### BACKGROUND OF THE INVENTION

1. Field of the Invention

The present invention relates to a battery charger base, and more particularly to a battery charger that provides an output and a use of an external AC power.

2. Description of the Related Art

Referring to FIG. 1 for a conventional battery charger 10, the battery charger 10 installs a charge circuit for inputting AC power to be converted into DC power, and includes a main body 11 having a plurality of charging slots 12 for installing and charging chargeable batteries. However, this kind of battery chargers inserted into a power socket for inputting AC power simply provides a function of charging the battery, but it also occupies the position of an insert hole of a socket. As present 3C electronic products become increasingly popular, the demand for battery power increases drastically and one battery charger cannot meet the requirements for the expanded power supply.

Therefore, it is an important subject for manufacturers to overcome the foregoing shortcomings of the prior art and develop a battery charger having a charging function and being capable of connecting an external AC power to output the required power.

### SUMMARY OF THE INVENTION

In view of the foregoing shortcomings of the prior art, the inventor of the present invention based on years of experience in the related industry to conduct extensive researches and experiments, and finally developed a battery charger in accordance with the present invention to overcome the foregoing shortcomings of the prior art.

The primary objective of the present invention is to provide a battery charger base capable of connecting an external AC power output, and the design of an overload protection circuit and an external AC power socket is added to the original components, not only providing the charging and rectifying functions, but also forming a socket capable of outputting an AC power.

To achieve the foregoing objectives, the present invention provides a battery charger capable of connecting to an external AC power, and the battery charger comprises a main body, an input plug, a charge rectification circuit, a charge slot, an overload protection circuit and an external AC power socket. The main body is built for containing the input plug, charge rectification circuit, charge slot, overload protection circuit and external AC power socket to provide an insulation protection. The charge circuit is electrically connected to the input plug for converting an input of AC power into an output of DC power. The charge slot is electrically connected to the charge circuit for installing and charging a chargeable battery of an AA or AAA specification. The overload protection circuit is electrically connected to the input plug for protecting the input of AC power from having a load of a large current on the circuit. The external AC power socket is electrically connected to the overload protection circuit for outputting a stable AC power.

To make it easier for our examiner to understand the objective, shape, structure, apparatus, characteristics and performance of the present invention, the following detailed description with reference to the accompanying drawing of preferred embodiments is given for example, but such preferred embodiments are not intended to limit the scope of the present invention.

### BRIEF DESCRIPTION OF THE DRAWINGS

FIG. 1 is a schematic view of a prior art battery charger;

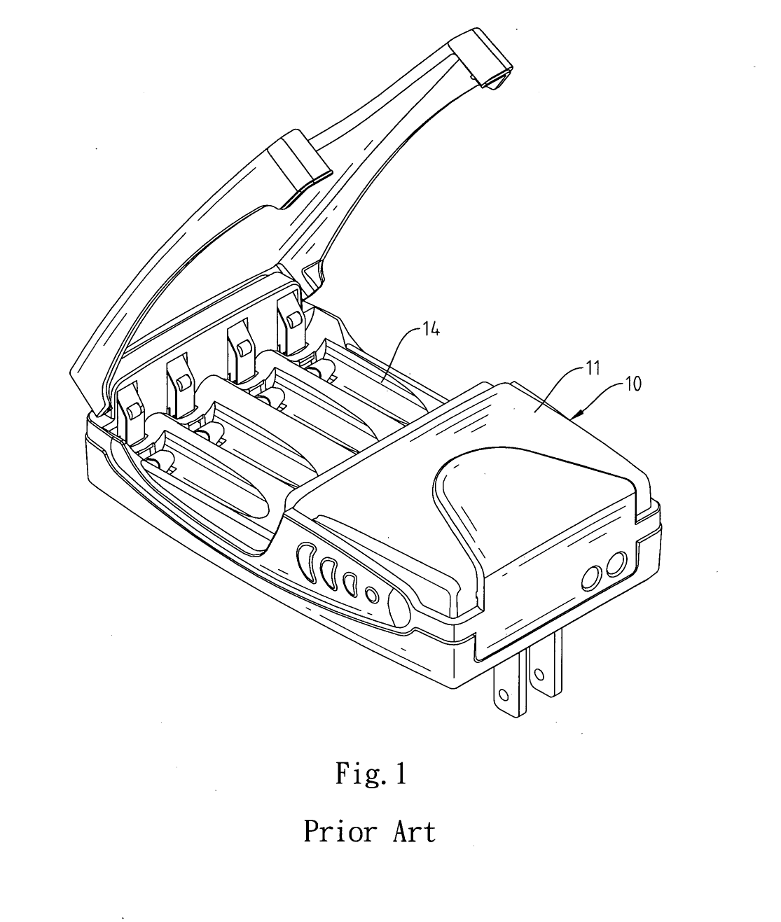

FIG. 2 is a schematic view of a battery charger connected to an external AC power in accordance with the present invention;

FIG. 3 is a schematic view of the connection of related components of a battery charger connected to an external AC power in accordance with the present invention;

FIG. 4 is a schematic view of a battery charger connected to an external AC power in accordance with a preferred embodiment of the present invention; and

FIG. 5 is a schematic view of a plurality of battery chargers stacked with each other and connected to an external AC power in accordance with a preferred embodiment of the present invention.

### DETAILED DESCRIPTION OF THE PREFERRED EMBODIMENTS

The description and its accompanied drawings are used for describing a preferred embodiment of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

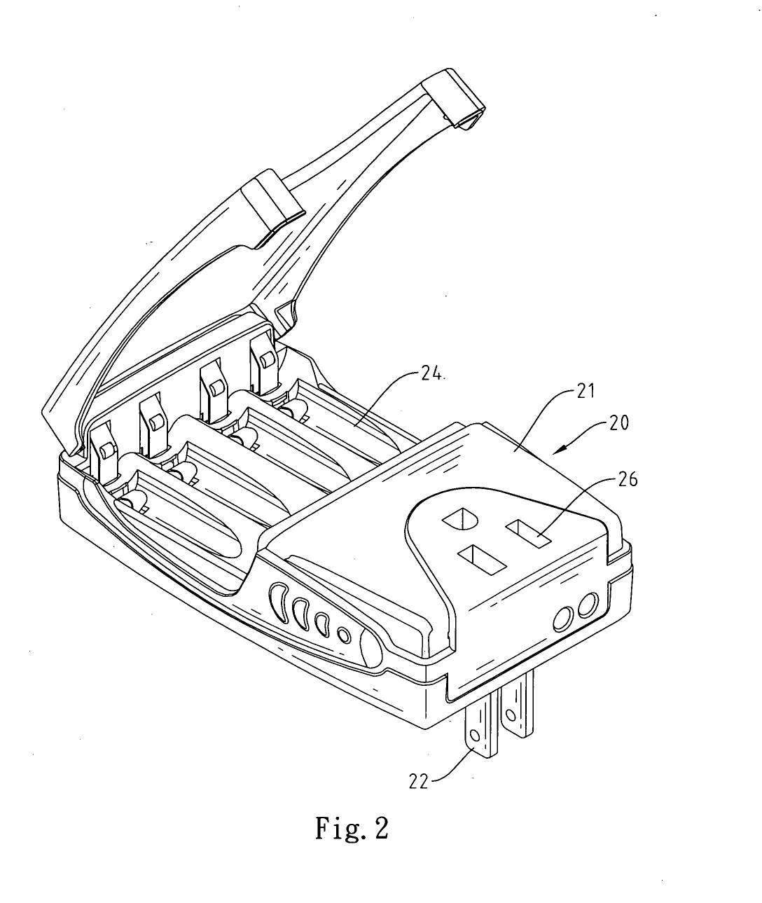

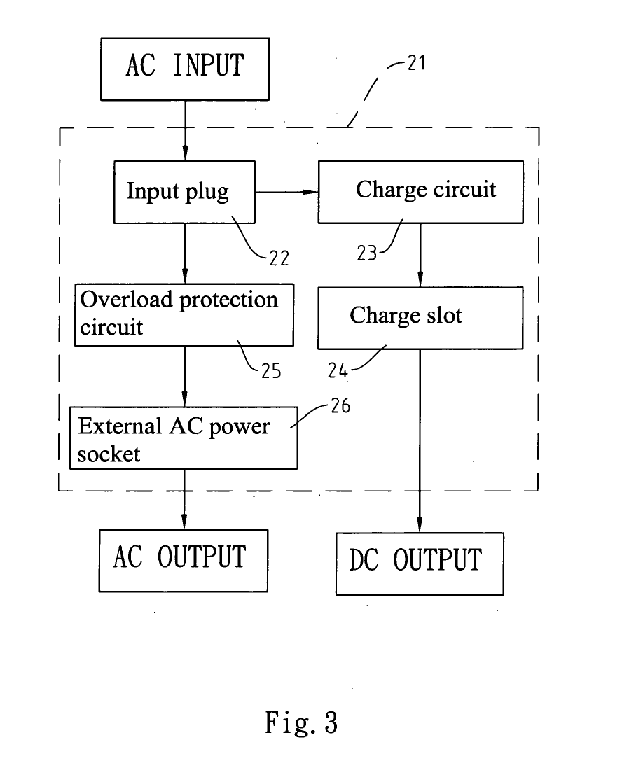

Referring to FIGS. 2 and 3 for schematic views of a battery charger connected to an external AC power in accordance with the present invention, the battery charger 20 comprises a main body 21, an input plug 22, a charge circuit 23, a charge slot 24, an overload protection circuit 25 and an external AC power socket 26.

The main body 21 is built for containing any of the input plug 22, charge circuit 23, charge slot 24, overload protection circuit 25 and external AC power socket 26 to provide an insulation protection for the aforementioned components, and the input plug 22 is provided for inserting a power socket to input AC power, and the charge circuit 23 is electrically connected to the input plug 22 for inputting AC power to be converted and rectified into an output of the required DC power, and the charge slot 24 is electrically connected to the charge circuit 23, such that the chargeable battery is installed into the charge slot 24 for a battery charge. In this preferred embodiment, there are a plurality of charge slots for installing and charging chargeable batteries of an AA or AAA specification. The quantity of the charge slots 24 adopted in this embodiment is used for the illustration purpose only, but not intended to limit the invention. Further, the overload protection circuit 25 is electrically connected to the input plug 22 for inputting AC power and preventing a circuit from having a load with a large current, and the external AC power socket 26 is electrically connected to the overload protection circuit 24 for outputting a stable AC power, and thus the external AC power socket 26 can be connected to a load device that requires an AC power, and prevent an overload of the externally connected load device. This safety measure can safeguard the load device from an overload of power supply.

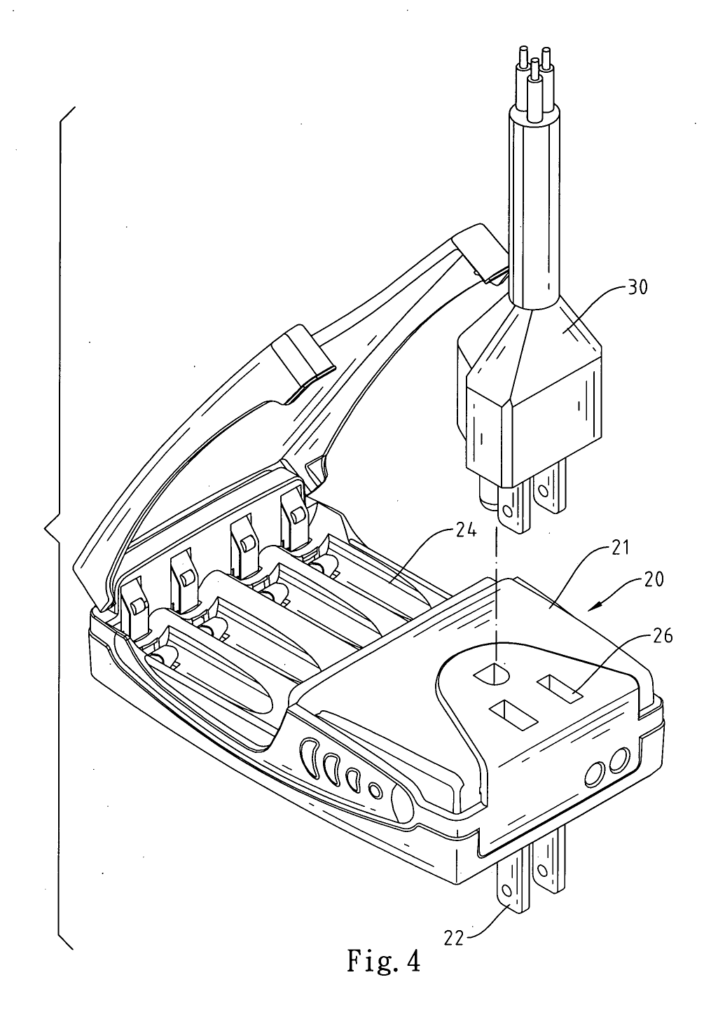

In the preferred embodiment as shown in FIG. 4, the battery charger of the invention has a feature of connecting an external expanded AC power, such that a load device can be inserted into an external AC power socket 26 through a power connector 30 for supplying the required stable AC power, and thus the battery charger of the invention not only has the function of charging a battery, but also connects a socket for an external AC power. The present invention does not occupy an insert slot of the socket, when the battery charger is inserted into the power socket.

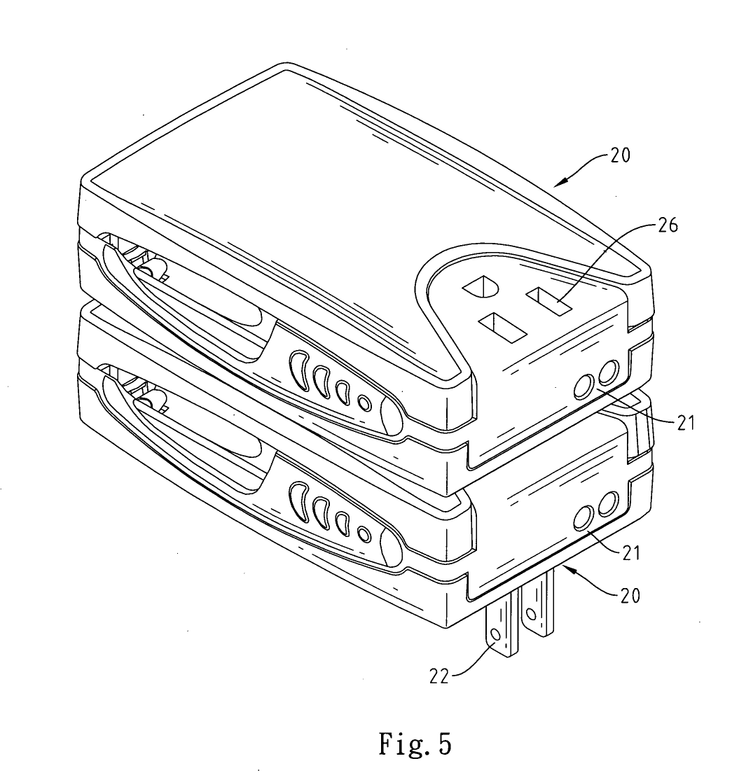

In the preferred embodiment as shown in FIG. 5, the battery charger of the invention has a feature of connecting an external expanded AC power, and a plurality of battery chargers are stacked with each other to connect an external AC power without occupying an insert slot of the socket, while providing an application of connecting several battery chargers to an external AC power supply.

In summation of the description above, the present invention provides a battery charger connected to an external AC power, and the design of an overload protection circuit and an external AC power socket is added to the original components, not only providing the charging and rectifying functions, but also forming a socket capable of outputting an AC power. Obviously, the present invention complies with the requirements of patent application, and thus is duly filed for patent application.

What the invention claimed is:

1. A battery charger base, comprising a main body, an input plug, a charge rectification circuit, and a charge slot, and said charge circuit being electrically coupled to said input plug for converting and rectifying an input of AC power into an output of a required DC power, and said charge slot being electrically coupled to said charge circuit for installing a chargeable battery for performing a battery charge, wherein said battery charger base comprises an overload protection circuit and an external AC power socket, and said overload protection circuit is electrically coupled to said input plug for preventing an input of AC power from having a load of a large current on said circuit, and said external AC power socket is electrically coupled to said overload protection circuit for outputting a stable AC power.
